(19) United States
(12) Patent Application Publication
(10) Pub. No.: US 2023/0090073 A1
(43) Pub. Date: Mar. 23, 2023

(54) BELLOWS SUSPENSION COMPOSITE SPRING

(71) Applicants: Max SARDOU, Saint-Soupplets (FR); Patricia SARDOU, Saint-Soupplets (FR)

(72) Inventors: Max SARDOU, Saint-Soupplets (FR); Patricia SARDOU, Saint-Soupplets (FR)

(21) Appl. No.: 17/949,855

(22) Filed: Sep. 21, 2022

(30) Foreign Application Priority Data
Sep. 23, 2021 (FR) 2112416

(51) Int. Cl. F16F 9/04

(52) U.S. Cl. CPC F16F 9/0409; F16F 9/0418; F16F 2224/0241; F16F 2234/02

(57) ABSTRACT

Disclosed is an elastic compression device for storing, thanks to a composite spring, large elastic energies under a small mass, suitable for astronautics, aeronautics, elastic suspension elements for automotive and rail transport, and industrial mechanisms. This is achieved by a device, tolerant to damage, offering immunity to creep, shocks to corrosion and notch while reaching levels of considerable energy density, namely 1,400 J/kg, which is 4.66 times more than of steel springs. The device has a bellows shape, of its elastic element of compression, which shape includes at least one portion of an ellipse, terminated by supports. Further, the device is leakproof, so that the device can contain pressurized gas or fluid and can be used as an air or a hydraulic strut.

### CROSS-REFERENCE TO RELATED APPLICATIONS

This application claims priority to French Patent Application No. 2112416 filed Sep. 23, 2021, the entire contents of which are hereby incorporated by reference.

### BACKGROUND OF THE INVENTION

### Field of the Invention

The present invention relates to elastic compression devices for storing, thanks to a composite spring, large elastic energies under a small mass, for the following applications fields:
astronautics, aeronautics, for example for the manufacture of elements to separate two rocket stages during their ascent, or to remove boosters from a rocket, eject the cap or place satellites in orbit.
   elastic suspension elements intended for motor, industrial or similar transport. industrial mechanisms.

### Description of the Related Art

It is known that steel springs have relatively modest energy densities of 250 or even 300 Joules per kilogram (J/kg).

Metal springs are sensitive to corrosion and notching, which leads to explosive rupture of these.

Composite coil springs, which we invented, manage to achieve energy densities of 600 J/kg.

Composite springs have a fibrous glass structure that allows them to be immune to corrosion and notch shocks (they are said to be damage tolerant).

All the springs of the prior art suffer from the serious problem called creep; that is, they lose load, gradually, when compressed for a long time.

### Previous Composite Springs

The European patent 94401868.8 of 18 Aug. 1994 under priority of the patent FR 9310146 of 20 Aug. 1993 (of the author) describes a spring in the shape of a “C”, this spring uses a ribbon having a width substantially equal to the width of the spring and a thickness perpendicular to said spring significantly less. The said composite reinforcement tape is wound continuously around the spring circling the central spacer and the fixing eyes uninterruptedly. In other words, said ribbon travels for example the extrados of the spacer, then turns around the eye of one end and returns to the other eye by going through the intrados of the spring, it then turns around the second eye and leaves on the extrados (for a finite number of turns). When loading the eyes, i.e., when applying a force to bring them closer together. In the configuration claimed by the FR 9310146 patent, the following phenomena are observed: the eyes grow on the area of the ribbon located on the side of the intrados. The tape, under load, peels off the spacer, this inevitably causes the total delamination of the tape layer and the ruin of the spring. In addition, the spacer being of constant section the quadratic moment applied to the spring is not mastered. This is our very first spring and is therefore very far from mature. Such a spring is not able to store interesting energy.

Patent FR 85 13960 of 20 Sep. 1985 (applicant National Renault Authority) this patent deals with a leaf spring and how to fix its ends. There is absolutely no common ground between such a spring and an omega spring! In addition, putting an eye inside the spring blade is likely to cause delamination of the composite. Placing an eye between layers of composite is therefore also a very bad idea!

Patent JP 2015187459 A of 29 Oct. 2015, this patent in hairpin spring, with constant thickness and moreover the ends of said spring are pinched. This patent has no prior art to the invention.

Patent EP 0132 048 A1 of 23 Jan. 1985 this patent presents zig-zag springs consisting of ribbons with constant thickness and therefore without spacer to manage the moment applied along the said zigzag; moreover, the ends of the zigzag are not treated, nor clearly claimed as shown in FIG. 1 of the said patent.

Patent 1910754 of 28 Sep. 2019 (of the author) this patent describes a composite spring in the shape of “C” (see FIG. 1) and “S” (see FIG. 2), extremely efficient, offering an energy density of up to 1400 J/Kg and not sagging under load. This type of “C” spring has been successfully tested for 20 years under nominal load. The only unseemly of this spring is its geometry which imposes a dedicated integration, on the other hand it offers about 75% gain in mass and about 50% gain in cost compared to a steel coil spring.

Patent DE 10 2015 012334 B3 of 16 Feb. 2017 of Hoffmann, this patent presents a series of zigzag springs placed in circle around a centerline. These springs being independents each other. In addition, the zigzag springs do not have spacer in their apex; so, this patent is out of the scope of our patent: no spacers and independent zigzag

Patent DE 10 2019 109554 A1 of 15 Oct. 2020 of Danto invent GMBH, this patent presents a single zigzag spring having spacers in their apex; so, this patent is out of the scope of our patent having spacers on a single zigzag.

### SUMMARY OF THE INVENTION

The present invention relates to compression springs, it aims to achieve a device, damage tolerant, offering a perfect immunity to sag, shocks, corrosion, and notch, while reaching levels of considerable stored energy density namely 1,400 J/kg or even more!

The present invention is intended to make it possible to carry out a mastered loading of the composite.

The present invention aims to offer the benefits of the spring in “C”, more than 75% gain in mass and 50% gain in cost compared to a steel coil spring, while housing in the same volume as a coil spring.

The present invention removes the objections of vehicle platform managers, who wish to keep the possibility, at any time, to have the choice between the composite spring and a conventional coil spring.

### BRIEF DESCRIPTION OF THE DRAWINGS

The invention will be described in connection with the following drawing figures, in which:

FIG. 1 illustrates an elementary elastic part called spring in “C” or said in omega,

FIG. 2 illustrates an elementary elastic part called “S” spring, i.e., two “C” head-spade springs,

FIG. 3 is a schematic section view of an external ring bellows according to the invention,

FIG. 4 is a schematic exterior view of an external ring bellows according to the invention,

FIG. 5 is a schematic end view of an external ring bellows according to the invention, and

FIG. 6 is a schematic section view of an inner ring bellows according to the invention.

### IDENTIFICATION OF REFERENCE NUMERALS

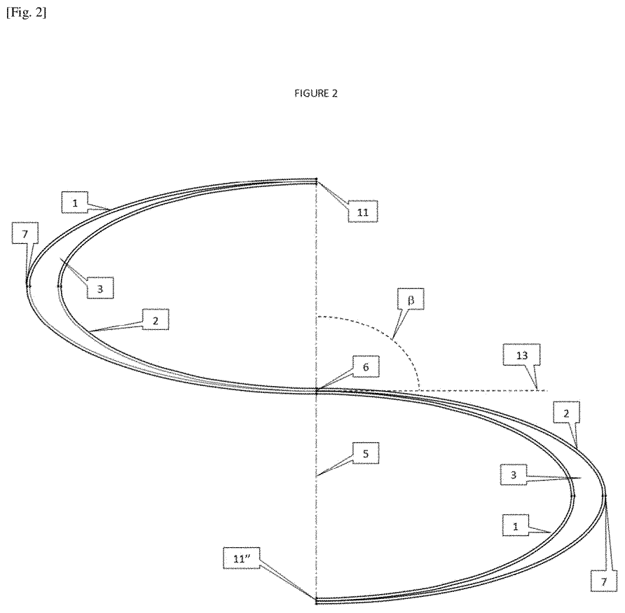

(1) composite tablecloth
(2) composite tablecloth
(3) (3′) type spacer (3)
(4) axis of symmetry
(5) local loading axis said: secondary curve portion
(6) connection of two head-spade springs
(7) apex of an elementary spring
(8) axis of revolution of the bellows (axis “Z”) says: portion of main curve
(9, 9′, 9″, 9″′) end of the connection between the composite tablecloth (1) and (2)
(10, 10′) Lower end of the elastic part of the bellows called (EI)
(10″,10″′) Upper end of the elastic part of the bellows called (ES)
(11, 11′) local loading area
(12, 12′) bellows closure zone
(13) tangent to the orientation of the composite tablecloth (1) and (2) to the points of type (6)
(A) end ring
(F1) local loading
(F1′) antagonistic local loading
(D1) distance of the loading axis from the section (S1) studied
(S1) Local Studied
(EI) lower end of bellows
(ES) upper end of bellows
(X, Y, Z) Orthonormed coordinate system
(α) reinforcement angle
(β) angle of the tangent (13) of the orientation of the composite tablecloth (1) and (2) to point (6) see FIG. 2.
(γ) angle formed by the fibres constituting the layers of type (3) and (3′):
   in relation to the direction of the axis (8).
   that is to say, in other words in relation to the wall constituted by the corrugated tubes of type (1) and (2) on which they are wound.

### DESCRIPTION OF THE PREFERRED EMBODIMENTS

In order to achieve our goals, we have designed a composite bellows spring called BELLOWSPRING.

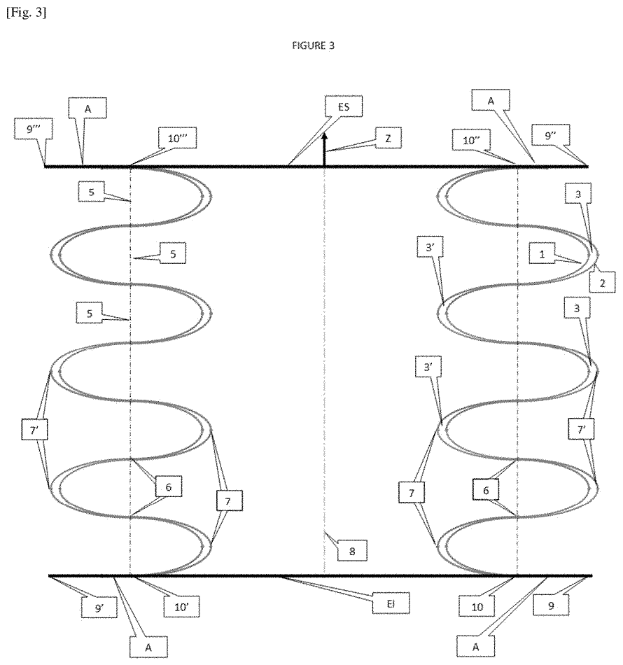

FIG. 3 shows a sectional view of the bellows

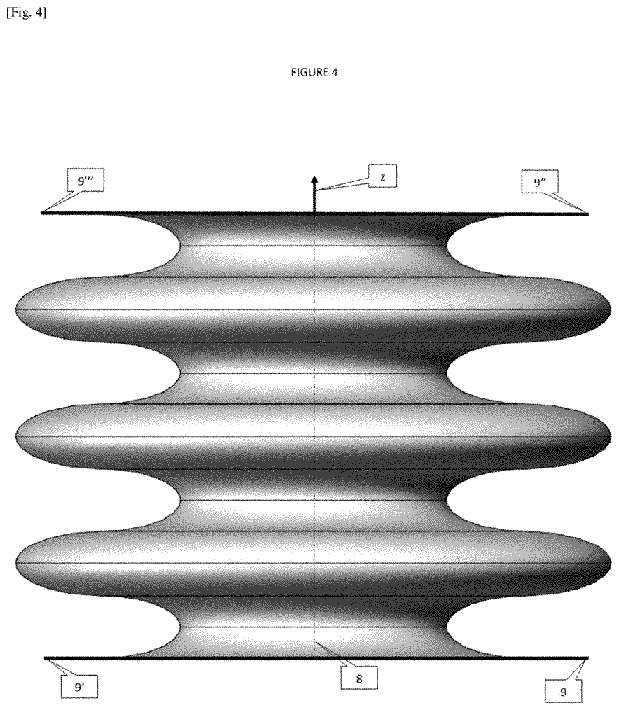

FIG. 4 shows bellows from the outside.

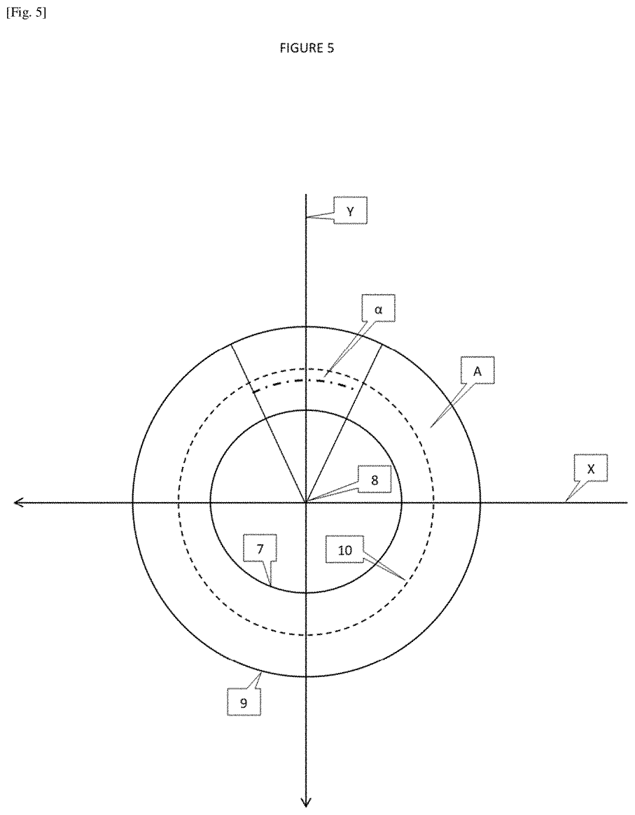

FIG. 5 The bellows wall, inspired by FIG. 2, as shown in FIG. 3 consists of a series of “S” springs placed end to end along the axis (5).

The bellows itself is obtained by “rotating” the axis (5) around the axis (8); we then obtain a bellows of revolution. See FIG. 4. This rotation of the axis (5) around the axis (8) creates a continuous bellows wall with a rotational symmetry, this wall being continuous, thus generating a sealed revolving wall as shown in FIG. 4, this wall being airtight and fluid tight.

Let's analyze how this spring works:

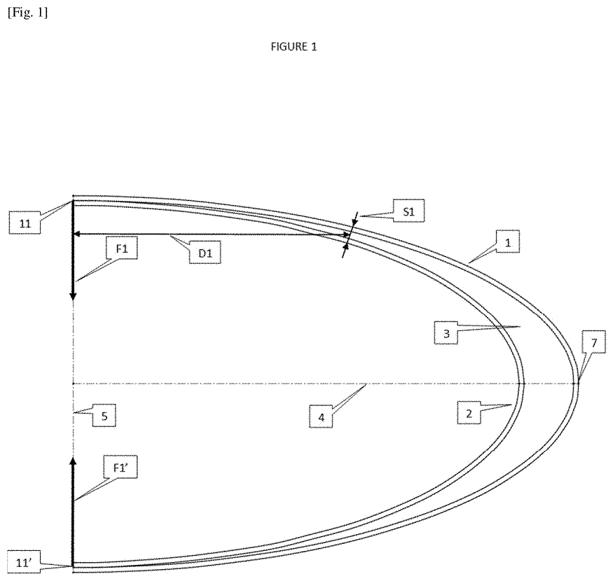

The working area is defined as the area from the loading point (11) to the opposite point (11′) in the case of a “C” spring (also called omega spring) (see FIG. 1).

FIG. 1 When loading the spring of FIG. 1, as described above, the tape (1), which travels the extrados, being in tension, tends to have a centripetal movement, that is, it pushes towards the intrados. In the opposite way the ribbon (2) that runs through the intrados is in compression, so it tends to push towards the extrados. In this device the two ribbons converge towards each other and compress the spacer (3).

So, we have a self-tightening structure [tape (1)/spacer (3)/tape (2)] absolutely unique and perfectly impossible to delaminate.

Omega springs, of our design, have been tested, under nominal load, for 20 years, without presenting any creep.

“Didactic” springs were provided with a layer of Teflon between the tape (2) and the spacer (3), these springs had the same compression properties as a spring without Teflon . . . .

The present invention is characterized by the so-called “C” shape of its elastic element; this precise shape, is drawn on the basis of portion(s) of ellipse, as shown in FIG. 1.

The immaterial line, passing through the loading areas respectively (11), (11′) is designated by the marker (5).

FIG. 1 is a view, very schematic, of an embodiment of an omega spring according to the invention.

The omega spring consists of unidirectional composite ribbon sheets (composed of fibers (or stratifils) and matrix) running uninterruptedly from the end (11) of the spring to the opposite end (11′), said spring.

We designate by extrados, the outer side of the omega, where the composite tablecloth is located (1), and by intrados the inner side of the omega where the composite tablecloth is located (2).

In the case of the spring of FIG. 1 There is therefore, mainly, an outer composite tablecloth (1), which works in pure traction and an inner composite tablecloth (2) which works in pure compression; each tablecloth may itself consist of one or more layers (under tablecloth) of composite.

FIG. 2 In the case of the spring of FIG. 2 There is therefore, mainly, a tablecloth (1) which is outer some time and which works in pure traction and inner some time, it then works in pure compression; reciprocally the composite tablecloth (2) works in opposition with the composite tablecloth (1) it is therefore first in compression and then in tension.

In the case of the spring of FIG. 3 there is a repetition of the case of FIG. 2 over the entire height of said spring, which is to say between (10)-(10″) and (10′)-(10″′)

In the case of the spring in FIG. 1, the curvilinear abscissa means the line from the end (11) to the end (11′) of the composite tablecloth, a line equidistant between the composite tablecloth (1) and (2).

Is designated by axis of symmetry (4) of the elementary spring of FIG. 1, the line starting from the apex (7) and perpendicular to the axis (5).

Apex means the point of the extrados of the spring furthest from the axis (5), in the plane of the spring of FIG. 1.

In the case of FIG. 1, between the composite tablecloth (1) and (2) there is, a spacer (3) which makes it possible to modulate the distance separating the composite tablecloth (1) and (2). The role of this spacer is to optimize the local relative deformation of the composite tablecloth (d1/1=called “epsilon”), along the curvilinear abscissa, in order to control the value of the local epsilon, and especially the epsilon of the fibers of surfaces of the composite tape in tension. The goal being, preferably, to maintain a value, of surface epsilon, as close as possible to the desired maximum, for a chosen loading case, over the greatest possible length of said curvilinear abscissa.

In other words, in the case of FIG. 1, for a load F1 and a distance D1, between the local section considered S1 and the loading axis (5), of said spring, the local thickness of the spacer (3) is modulated to, preferably, control the local bending moment M1 (equal to the product F1 per D1) applied to the local section (S1) of spring considered. If H1 is the local thickness of the section S1, if L1 is the width of the spring, and Igz1 the local quadratic moment and if, for simplicity, we consider here that the spacer (3) and that the composite tablecloths (1) and (2), are made of the same composite, we therefore have a local Igz1 equal to (L1*H13)/12=Igz1. The goal is preferably to keep the ratio R1=M1/Igz1 as constant as possible over the greatest possible curvilinear distance. This type of calculation, more precise, is easily conducted, either with the help of a spreadsheet software, or thanks to the calculation by finite elements; such an activity is easily accessible to the skilled person.

The spacer (3), in the case of FIG. 1, can be made of any material ranging from a rubber to pure matrix (thermosetting or thermoplastic) it can also be pure matrix loaded with unidirectional or short fibers. A preferable configuration is to make said spacer (3) by stacking sections of fiber-matrix composite ribbons, preferably unidirectional of different length from one section of tape to another so as to obtain the desired law of variation of thickness.

On the same principle, in the case of the BELLOWSPRING in FIG. 3, the spacers are to be calculated in order to control the ratio R1=M1/Igz1 by keeping it as constant as possible over the greatest possible curvilinear distance for each type 3 spacer.

In the case of the BELLOWSPRING of FIGS. 3 and 4 we therefore have corrugated composite tablecloth of type (1) and (2) of revolution around the axis (8), constituting the wall of the bellows, and going from one end to the other of the spring that is to say from the base (10)-(10′) to the vertex (10″)-(10″′); the spacers of type (3) of revolution around the axis (8), being arranged between the composite tablecloth of type (1) and (2), see the notation (3) for the spacers located on the convex part of the bellows and (3′) for those located on its concave part.

In order to reinforce the bonding between the composite tablecloth of type (1) and (2) of the bellows, it is advantageous to extend these by a ring (A) ranging from (10 to 9) so from (10′ to 9′) from (10″ to 9″) from (10″′ to 9″′).

Such a ring (A) also makes it possible to constitute a base of support of the bellows.

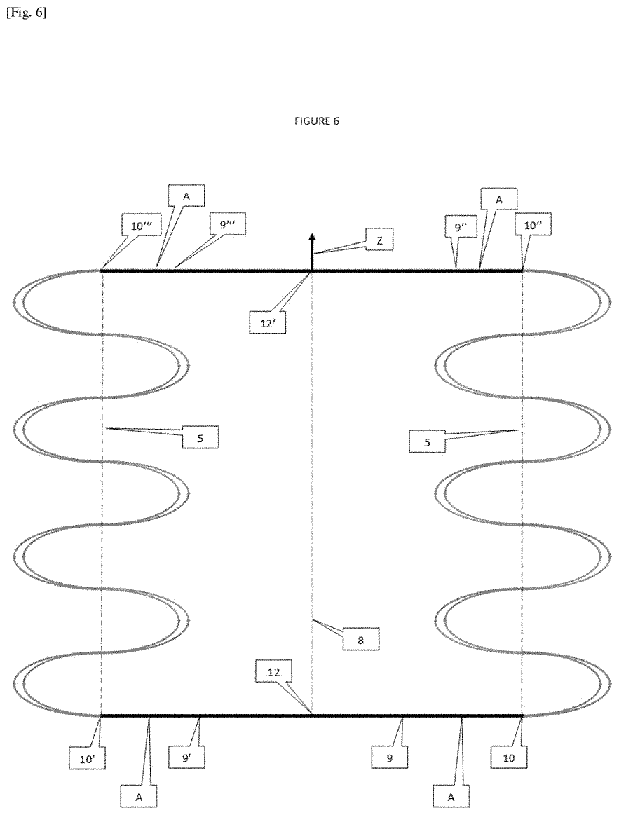

FIG. 6 Note that this ring (A) can be oriented outwards, as is the case in FIG. 3, or inwards, see FIG. 6. One can also mix and have for example a base like FIG. 3 and a vertex like FIG. 6 and vice versa. Note that this ring (A) can be oriented in any angle in reference to the end of the BELLOWSPRING (10-10′-10″-10″′) in particular the ring (A) can be perpendicular to the end of the BELLOWSPRING so that this ring (A) is being parallel and coaxial to the cylinder drawn by the axis 5 around the axis 8.

Note that it is possible to close both ends of the bellows, which is to say that the two bottoms ranging from (10 to 10′) and (10″ to 10″′) are closed airtight and fluid tight.

It is then possible to introduce a fluid, for example air or a gas compressed from water or oil into the bellows; one then has the possibility of having a suspension benefiting from the mechanical rigidity of the bellows and for example the pressure of the compressed gas. Thus, with a constant attitude, it is possible to withstand very different loads or to change the vehicle's attitude, depending on the terrain.

The present invention is characterized by an extreme ease of industrial realization, requiring only modest investments; it is also of a relatively simple and easy-to-use structure.

In particular this bellows can be mounted in place of a coil spring.

The spring, as described is cylindrical, it can be drawn in barrel, conical, single, or double “pig's tail”

The spring as described develops a perfectly axial thrust, which is to say aligned with the axis (8) (Z), because it consists mainly of the two layers of type (1) and (2) of revolution. It is possible to decenter, the said push, by adding a local overthickness. this thickness occupies the entire height of the bellows but only on an area defined by the angle (α) in FIG. 5

### NOTES

It is specified that adverbs preferentially, and optionally mean that one can preferably use a solution or that one can does not use it while remaining within the scope of the invention

It is well specified that, on the figures, the same references designate the same elements, whatever the figure on which they appear and whatever the form of representation of these elements. Similarly, if elements are not specifically referenced on one of the figures, their references can be easily found by referring to another figure.

The applicant also wishes to specify that the figures represent an embodiment of the object according to the invention, but that there may be other embodiments that meet the definition of this invention. For example, composite tablecloths or tubes of type (1) and type (2) can be: either being purely unidirectional (UD) ranging from (ES) to (EI) or being a mix of fibers (UD) going from (ES) to (EI), and fibers forming a non-zero angle with said fibers (UD), and in particular this angle can be 90°.

It further specifies that, where, according to the definition of the invention, the object of the invention comprises “at least one” element having a given function, the embodiment described may comprise several of these elements.

It also specifies that, if the embodiments of the object, according to the invention, as illustrated comprise several elements of identical function and that if, in the description, it is not specified that the object according to this invention must necessarily comprise a particular number of these elements, the object of the invention may be defined as comprising “at least one” of these elements.

It is specified that where, in this description, an expression alone defines, without any specific reference to it, a set of structural characteristics, those characteristics may be taken, for the definition of the object of protection sought, where technically possible, either separately or in total and/or partial combination.

It is specified that the invention relates to BELLOWSPRINGs, as described, that is to say having spacers of type (3 and 3′).

Finally, it is specified that by varying the value of the angle (β) at the points of type (6), we can adjust the evolution of the law of stiffness of the spring. Thus if (b) is less than 90° (for example 70°) at the beginning of compression and it reaches 90° in maximum compression, the spring will have an increasing stiffness.

It also clarifies that; the term substantially can mean that the property so qualified can be understood either as being exactly or as almost defined. For example, the property “fibers arranged substantially in sinusoids” can mean either that the fibers are arranged exactly in sinusoid, or that they are arranged according to a repetitive irregular arrangement, for example in “zigzag” or cross folds.

Finally, it is specified that the expression “type” makes it possible to design all points of the same type, which is to say similar. Thus, in FIG. 3 we have shown as an example point of type 6 in the lower part of the bellows, on the right and on the left, it is understood that the other areas of the same geometries are included in this definition. Similarly, the expression spacer of type (3) includes all spacers whether they are (3) or (3′)

Note that, in the case of the end of the bellows of type (10), namely (10 and 10′ and 10″ and 10″′), it is desirable to adopt locally the same angle adjustment (β)

### Definition

Pig's tail: in the case of a coil spring, it is one or more whorls whose winding diameter is less than the diameter of the main body of the spring, in order to interface with a spring seat of smaller diameter

Extrados: convex bulging part

Intrados: concave hollow part

Curvilinear abscissa: abscissa measured on the line equidistant between the layers of type (1) and (2) for example in FIG. 1.

UD: unidirectional fibers.

CE: Sequence of Elementary Cells.

AM: part furthest from the axis (5) of the elementary elastic part called “C” spring Composite tablecloth, or layers or layers of fiber-matrix composite materials is a composite tape made of fibers impregnated by resin

### Summary

Spring in particular for motor vehicles, comprising
an open annular chamber at both ends,
means of attachment with external elements, these means of attachment being mounted in cooperation respectively with the two ends of the said chamber,
said annular chamber comprising a side wall having a shape having periodic undulations, the undulations, of said chamber seen in section, having substantially a sinusoidal shape, each half-period being defined by a vertex and two feet, each of the said feet on either side of the summit being located on a curve called undulation curve,

That chamber comprises a side wall consisting of two layers of fibre-matrix composite materials, separated from the top to the feet by a thick composite spacer at the top and which refines towards the two feet of the half-period in such a way that the thickness, at the top of the half-period, is greater than the thickness taken at the feet and is continuously decreasing from the said apex to the two feet of the said half-period.

Spring whose shape of the annular chamber seen from the side is chosen from the following options: rectilinear, curve

Spring whose shape of the annular chamber seen at the end, or in a plane parallel to the ends of said chamber has a shape chosen from the following geometric figures: cylindrical, elliptical

Spring whose annular chamber, has a shape chosen from the following options: of constant diameter over its entire height, of variable diameter over all its height

Spring whose ripples of the annular chamber, are chosen from the following options: constant pitch ripples, variable pitch ripples.

Spring whose ripples of the annular chamber have a shape similar to a half-ellipse

Spring of which the two corrugated layers of “matrix-fiber” composite extending from one end of the annular chamber to the other consist of: on the one hand “fibers”, the fibers being made of one of the following materials: glass, basalt, carbon, aramid, high-density polyethylene and on the other hand a “matrix”, which is a substance intended to bind the fibres together, the matrix chosen from the following options: thermosetting, thermoplastic, rubber and can be of one of the following chemical types: epoxy, polyester, vinylester, polyamide, polyethylene, polyetherimide, polyimide, rubber.

Spring whose spacer, placed between the corrugated membranes, arranged at the top of the half period and extending towards the feet of each half period may according to one of the following options: be molded before placement, be deposited in situ, during the manufacture of the composite annular chamber, said spacer may be constituted, partially, of a part of “fibers”, chosen from the following configurations: continuous, chopped, the said fibers can be on the one hand of one of the following reinforcement fibers: glass, basalt, carbon, aramid, high-density polyethylene, and on the other hand, a matrix, the said spacer can be chosen from the following configurations: only pure “matrix”, a mixture of matrix fibers, said matrix can be of nature: thermosetting, thermoplastic, rubber and be of one of the following chemical types: epoxy, polyester, vinylester, polyamide, polyethylene, polyetherimide, polyimide, rubber.

Spring such that the upper and lower ends of the annular chamber are closed, by two seals located at the level of the said ends, said chamber being thus made watertight, it is then possible to introduce at choice: a fluid, a gas under pressure to vary the height under load and the stiffness of said spring.

1. A spring, comprising:
an annular bellows chamber being obtained by stacking a series of S-shaped springs placed end to end along an axis then by rotating the axis around the central axis of the bellows, thus generating a sealed revolving wall, said chamber being open at both ends, and
means of attachment with external elements, these means of attachment being mounted in cooperation respectively with the two ends of the said chamber,
said annular chamber comprising a lateral wall having a shape having periodic undulations, the undulations, of said chamber seen in section, in elevation, having substantially a sinusoidal shape, each half-period being defined by a vertex and two feet, each of the said feet on either side of the summit being located on a curve known as the undulation curve,
wherein said lateral wall has two layers of layers of fiber-matrix composite material, separated, from the top toward the feet by a composite spacer, said composite spacer being thick at the top, and which refines towards both feet of the half-period, in such a way that the thickness, at the top of the half-period, is greater than the thickness taken at the feet is continuously decreasing, from the said summit to the two feet of the said half-period.

2. The spring according to claim 1, wherein the portion of the annular chamber seen from the side is rectilinear.

3. The spring according to claim 1, wherein seen in a plane parallel to the end plane, said chamber has a cylindrical shape.

4. The spring according to claim 1, wherein the annular chamber has a constant diameter over the annular chamber's height.

5. The spring according to claim 1, wherein the ripples of the annular chamber have a constant pitch.

6. The spring according to claim 1, wherein the ripples of the annular chamber have a shape of a half-ellipse.

7. The spring according to claim 1, wherein the fiber-matrix composite material comprises fibers of a material selected from the group consisting of: glass, basalt, carbon, aramid, and polyethylene with high density, and wherein the fiber-matrix composite material comprises a matrix that binds the fibers together, the matrix being of a type selected from the group consisting of thermoset, thermoplastic, and rubber, the matrix being of a chemical type selected from the group consisting of: epoxy, polyester, vinyl ester, polyamide, polyethylene, polyetherimide, polyimide, and caoutchouc.

8. The spring according to claim 1, wherein the spacer disposed between the corrugated layers, arranged at the top of the half period and extending towards the feet of each half period, consists of the matrix.

9. The spring according to claim 1, wherein the upper and lower ends of the annular chamber are closed, by two supports located at the level of said ends, so that said chamber is leakproof, the chamber containing a liquid or a gas, the liquid or gas being under pressure to vary the height under load and the stiffness of said spring.

10. The spring of claim 1, wherein the portion of the annular chamber seen from the side is curved.

11. The spring according to claim 1, wherein seen in a plane parallel to the end plane, said chamber has an elliptical shape.

12. The spring according to claim 1, wherein the annular chamber has a variable diameter over the annular chamber's height.

13. The spring according to claim 1, wherein the ripples of the annular chamber have a variable pitch.

14. The spring according to claim 1, wherein the spacer disposed between the corrugated layers, arranged at the top of the half period and extending towards the feet of each half period, is a mixture of a matrix and fibers.

15. The spring according to claim 14, wherein the fibers have a composition selected from the group consisting of: glass, basalt, carbon, aramid, and high-density polyethylene.

16. The spring according to claim 1, wherein the spacer disposed between the corrugated layers, arranged at the top of the half period and extending towards the feet of each half period, comprises a matrix, wherein the matrix is of a type selected from the group consisting of: thermosetting, thermoplastic, rubber.

17. The spring according to claim 1, wherein the spacer disposed between the corrugated layers, arranged at the top of the half period, and extending towards the feet of each half period, comprises a matrix, wherein the matrix is of a chemical type selected from the group consisting of: epoxy, polyester, vinyl ester, polyamide, polyethylene, polyetherimide, and polyimide, rubber.

18. The spring according to claim 2, wherein seen in a plane parallel to the end plane, said chamber has a cylindrical shape.

19. The spring according to claim 2, wherein the annular chamber has a constant diameter over the annular chamber's height.

20. The spring according to claim 3, wherein the annular chamber has a constant diameter over the annular chamber's height.
